(19) United States
(12) Patent Application Publication
(10) Pub. No.: US 2024/0184887 A1
(43) Pub. Date: Jun. 6, 2024

(54) ACTIVITY TRACE EXTRACTION DEVICE, ACTIVITY TRACE EXTRACTION METHOD, AND ACTIVITY TRACE EXTRACTION PROGRAM

(71) Applicant: NIPPON TELEGRAPH AND TELEPHONE CORPORATION, Tokyo (JP)

(72) Inventors: Toshinori USUI, Musashino-shi, Tokyo (JP); Tomonori IKUSE, Musashino-shi, Tokyo (JP); Yuhei KAWAKOYA, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/281,776

(22) PCT Filed: Mar. 16, 2021
(86) PCT No.: PCT/JP2021/010706

§ 371 Date: Sep. 13, 2023

(51) Int. Cl. G06F 21/56

(52) U.S. Cl. CPC G06F 21/566; G06F 2221/033

(57) ABSTRACT

An activity trace extraction device includes: an acquisition unit that acquires information regarding behavior of malware; a detection unit that detects an activity trace of the malware on the basis of the information regarding behavior of malware acquired by the acquisition unit; an addition unit that executes taint analysis on the malware and adds a taint tag based on the taint analysis to an output value of a predetermined application programming interface (API) in a case where the malware calls the API; a determination unit that determines presence or absence of dependency of the activity trace on the basis of the taint tag added by the addition unit; and an extraction unit that extracts the activity trace as an activity trace effective for detecting the malware in a case where the determination unit determines that there is no dependency of the activity trace.

### TECHNICAL FIELD

The present invention relates to an activity trace extraction device, an activity trace extraction method, and an activity trace extraction program.

### BACKGROUND ART

In recent years, with the sophistication of malware, malware that is difficult to detect by conventional anti-virus software that detects on the basis of signatures has increased. In addition, although there is detection by a dynamic analysis sandbox that operates transmitted and received files in an isolated environment for analysis and detects malware from a malignancy of an observed behavior, the environment for analysis is sensed and avoided by a method of viewing the degree of deviation from a general user environment or the like.

Under such a background, an anti-malware technology called EDR (endpoint detection and response) has been used. In the EDR, the behavior of the terminal is continuously monitored using an agent installed in the terminal of the user instead of an environment prepared for analysis. Also, malware is detected using trace information (IOC: Indicator of Compromise) which is prepared in advance and is a so-called signature of behavior for detecting a trace left when malware is activated. Specifically, the EDR collates the IOC with the behavior observed at the terminal, and detects that there is a suspicion of malware infection if they match.

Therefore, whether or not malware can be detected by the EDR depends on whether IOCs useful for detecting certain malware are retained. On the other hand, in a case where the IOC matches not only malware but also traces of activity of legitimate software, there is a problem that erroneous detection occurs. Therefore, it is necessary to selectively extract traces useful for detection to obtain IOCs, rather than merely randomly increasing the number of malware traces as IOCs.

In addition, it is necessary to selectively extract traces useful for detection to obtain IOCs from the viewpoint of IOCs that EDR can collate at one time. That is, since EDR generally takes more time for collation when it has more IOCs, it is desirable to have a combination of IOCs that detect more types of malware with a smaller number of IOCs. At that time, if an IOC is generated from an activity trace that is not useful for detection, it leads to unnecessary time for collation.

At present, new malware is created every day, and IOCs corresponding thereto also continue to change. Therefore, in order to continuously cope with them, it is necessary to automatically analyze malware, extract a trace of activity, and generate IOCs. IOCs are generated on the basis of an activity trace obtained by analyzing malware. In general, a trace obtained by executing malware while monitoring the behavior of malware is collected, and the trace is normalized or a combination suitable for detection is selected to obtain an IOC. From the above, there is a demand for a technique for selectively and automatically extracting an activity trace useful for detecting malware.

For example, Non Patent Literature 1 proposes a method of extracting a pattern of traces repeatedly observed among a plurality of pieces of malware and using the pattern as an IOC. In addition, Non Patent Literature 2 proposes a method of automatically generating an IOC that is easy for humans to understand by extracting a set of traces co-occurring between malware of the same family and preventing an increase in the complexity of the IOC by a set optimization method. According to these methods, it is possible to automatically extract an IOC that can contribute to malware detection from execution trace logs.

Here, the execution trace is to track the execution status of a program by sequentially recording behaviors from various viewpoints at the time of execution. In order to realize this, a program having a function of monitoring and recording behavior is called a tracer. For example, a program in which executed application programming interfaces (APIs) are sequentially recorded is called an API trace, and a program for realizing the API trace is called an API tracer.

### CITATION LIST

### Non Patent Literature

Non Patent Literature 1: Christian Doll et al. “Automated Pattern Inference Based on Repeatedly Observed Malware Artifacts.” Proceedings of the 14th International Conference on Availability, Reliability and Security. 2019.
Non Patent Literature 2: Yuma Kurogome et al. “EIGER: Automated IOC Generation for Accurate and Interpretable Endpoint Malware Detection.” Proceedings of the 35th Annual Computer Security Applications Conference. 2019.

### SUMMARY OF INVENTION

### Technical Problem

However, in the above-described related art, there is a problem that the time dependency and the environment dependency of the malware activity trace are not considered, and an activity trace that is not effective for malware detection can also be used as an IOC.

Here, the time dependency of the activity trace is a characteristic that the activity trace changes depending on temporal information at the time of execution of malware. The temporal information includes time, elapsed time from startup, and the like. Time-dependent activity traces cannot be used as IOCs due to generally different temporal information in the collected analysis environment and the environment actually attacked.

In addition, the environment dependency of the activity trace is a characteristic that the activity trace changes depending on environmental information at the time of execution of malware. The environmental information includes various setting information of the system or the device. For example, it is conceivable to change the activity trace on the basis of a universally unique identifier (UUID) of a system disk. Environment-dependent activity traces cannot be also used as IOCs due to differences in environmental information between the collected analysis environment and the environment actually attacked.

From the above, it is important to determine whether or not the collected malware activity trace has time dependency or environment dependency in order to selectively extract an activity trace effective for malware detection and generate an IOC.

### Solution to Problem

In order to solve the above-described problems and achieve the object, an activity trace extraction device according to the present invention includes: an acquisition unit that acquires information regarding behavior of malware; a detection unit that detects an activity trace of the malware based on the information acquired by the acquisition unit; an addition unit that executes taint analysis on the malware and adds a taint tag based on the taint analysis to an output value of a predetermined application programming interface (API) in a case where the malware calls the API; a determination unit that determines presence or absence of dependency of the activity trace based on the taint tag added by the addition unit; and an extraction unit that extracts the activity trace as an activity trace effective for detecting the malware in a case where the determination unit determines that there is no dependency.

Furthermore, an activity trace extraction method according to the present invention is an activity trace extraction method executed by an activity trace extraction device, the activity trace extraction method including: an acquisition step of acquiring information regarding behavior of malware; a detection step of detecting an activity trace of the malware based on the information acquired by the acquisition step; an addition step of executing taint analysis on the malware and adding a taint tag based on the taint analysis to an output value of a predetermined API in a case where the malware calls the API; a determination step of determining presence or absence of dependency of the activity trace based on the taint tag added by the addition step; and an extraction step of extracting the activity trace as an activity trace effective for detecting the malware in a case where it is determined in the determination step that there is no dependency.

Furthermore, an activity trace extraction program according to the present invention causes a computer to execute: an acquisition step of acquiring information regarding behavior of malware; a detection step of detecting an activity trace of the malware based on the information acquired by the acquisition step; an addition step of executing taint analysis on the malware and adding a taint tag based on the taint analysis to an output value of a predetermined API in a case where the malware calls the API; a determination step of determining presence or absence of dependency of the activity trace based on the taint tag added by the addition step; and an extraction step of extracting the activity trace as an activity trace effective for detecting the malware in a case where it is determined in the determination step that there is no dependency.

### Advantageous Effects of Invention

In the present invention, it is possible to precisely detect the presence or absence of dependency of an activity trace on the basis of tracking of a data flow of malware, and selectively extract an activity trace effective for detecting malware without dependency.

### BRIEF DESCRIPTION OF DRAWINGS

FIG. 1 is a diagram illustrating a configuration example of an activity trace extraction system according to a first embodiment.

FIG. 2 is a block diagram illustrating a configuration example of an activity trace extraction device according to the first embodiment.

FIG. 3 is a diagram illustrating an example of an API trace and an activity trace according to the first embodiment.

FIG. 4 is a diagram illustrating an example of a time-dependent activity trace according to the first embodiment.

FIG. 5 is a diagram illustrating an example of an environment-dependent activity trace according to the first embodiment.

FIG. 6 is a diagram illustrating an example of detection of an activity trace having dependency by a taint tag according to the first embodiment.

FIG. 7 is a flowchart illustrating an example of a flow of entire processing according to the first embodiment.

FIG. 8 is a flowchart illustrating an example of a flow of taint analysis processing according to the first embodiment.

FIG. 9 is a flowchart illustrating an example of a flow of dependency determination processing according to the first embodiment.

FIG. 10 is a flowchart illustrating an example of a flow of activity trace extraction processing according to the first embodiment.

FIG. 11 is a diagram illustrating a computer that executes a program.

### DESCRIPTION OF EMBODIMENTS

Hereinafter, embodiments of an activity trace extraction device, an activity trace extraction method, and an activity trace extraction program according to the present invention will be described in detail with reference to the drawings. Note that the present invention is not limited to the embodiments described below.

### First Embodiment

Hereinafter, a configuration of an activity trace extraction system, a configuration of an activity trace extraction device, a specific example of various types of information, a flow of entire processing, a flow of taint analysis processing, a flow of dependency determination processing, and a flow of activity trace extraction processing according to the present embodiment will be described in order, and finally, effects of the present embodiment will be described.

### [Configuration of Activity Trace Extraction System]

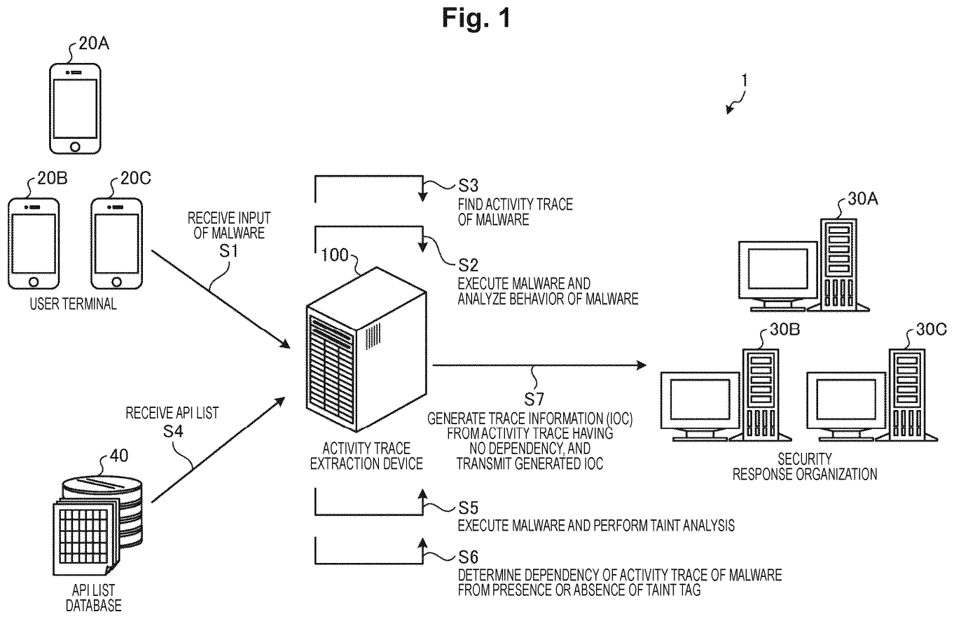

A configuration of an activity trace extraction system (appropriately referred to as the present system) 1 according to the present embodiment will be described in detail with reference to FIG. 1. FIG. 1 is a diagram illustrating a configuration example of an activity trace extraction system according to a first embodiment. The present system 1 includes an activity trace extraction device 100, user terminals 20 (20A, 20B, 20C) such as various terminals, security countermeasure organizations 30 (30A, 30B, 30C) such as a security operation center (SOC) and a computer security incident response team (CSIRT), and an API list database 40. Here, the activity trace extraction device 100, the user terminals 20, the security countermeasure organizations 30, and the API list database 40 are communicatively connected in a wired or wireless manner via a predetermined communication network (not illustrated). The activity trace extraction system 1 illustrated in FIG. 1 may include a plurality of activity trace extraction devices 100 and a plurality of API list databases 40.

First, the activity trace extraction device 100 receives an input of malware from the user terminal 20 (step S1). Here, the user terminal 20 is a personal computer (PC), a smartphone, a tablet terminal, or the like owned by a user of a general network or the like, but is not particularly limited thereto. The user terminal 20 may be a dedicated device that collects malware information.

Next, the activity trace extraction device 100 executes malware that has been received as an input and analyzes a behavior of the malware (step S2). At this time, the activity trace extraction device 100 acquires an information source for obtaining an activity trace of the malware. Specifically, the activity trace extraction device 100 acquires information regarding the behavior (appropriately referred to as “behavior information”) of the malware. Detailed behavior information acquisition processing by the activity trace extraction device 100 will be described later in [Flow of Entire Processing].

Subsequently, the activity trace extraction device 100 finds an activity trace of malware from the obtained behavior information (step S3). At this time, the activity trace extraction device 100 obtains an activity trace that does not consider the presence or absence of dependency of the activity trace of malware. Detailed activity trace finding processing (appropriately referred to as “activity trace detection processing”) by the activity trace extraction device 100 will be described later in [Flow of Entire Processing].

On the other hand, the activity trace extraction device 100 receives an API list from the API list database 40 (step S4). Here, the API described in the API list received by the activity trace extraction device 100 is an API for acquiring system information, time information, device information, and the like, but is not particularly limited, and may be an API for acquiring information specific to an application.

In addition, the activity trace extraction device 100 executes malware that has been received as an input and performs taint analysis (step S5). At this time, the activity trace extraction device 100 sets a taint analysis engine to add a taint tag to an output value of the API described in the API list, executes the malware on the taint analysis engine, and propagates the taint tag in accordance with the data flow. Detailed taint analysis processing by the activity trace extraction device 100 will be described later in [Flow of Taint Analysis Processing].

Furthermore, the activity trace extraction device 100 determines the presence or absence of dependency of an activity trace of malware from the presence or absence of the above-described taint tag (step S6). At this time, the activity trace extraction device 100 acquires the activity trace detected in the activity trace detection processing described above, and checks whether or not the taint tag has been added to the activity trace obtained in the taint analysis processing corresponding to the activity trace. Then, the activity trace extraction device 100 determines that the activity trace to which the above-described taint tag has been added has dependency, and determines that the activity trace to which the above-described taint tag has not been added has no dependency. Detailed dependency determination processing by the activity trace extraction device 100 will be described later in [Flow of Dependency Determination Processing].

Finally, the activity trace extraction device 100 generates trace information (IOC) from an activity trace having no dependency, and transmits the generated IOC to the security countermeasure organization 30. A terminal or the like to which the activity trace extraction device 100 transmits the IOC is not particularly limited.

The activity trace extraction system 1 according to the present embodiment analyzes malware to acquire behavior information, finds an activity trace of malware from the acquired behavior information, tracks a data flow by adding and propagating a taint tag, determines dependency of the activity trace on the basis of the activity trace and the taint tag, and selectively extracts only an activity trace having no dependency. Therefore, the present system 1 can precisely detect the presence or absence of dependency of the activity trace on the basis of the tracking of the data flow, and selectively extract the activity trace effective for detecting malware without dependency. In addition, the present system 1 can contribute to generation of an effective IOC.

### [Configuration of Activity Trace Extraction Device]

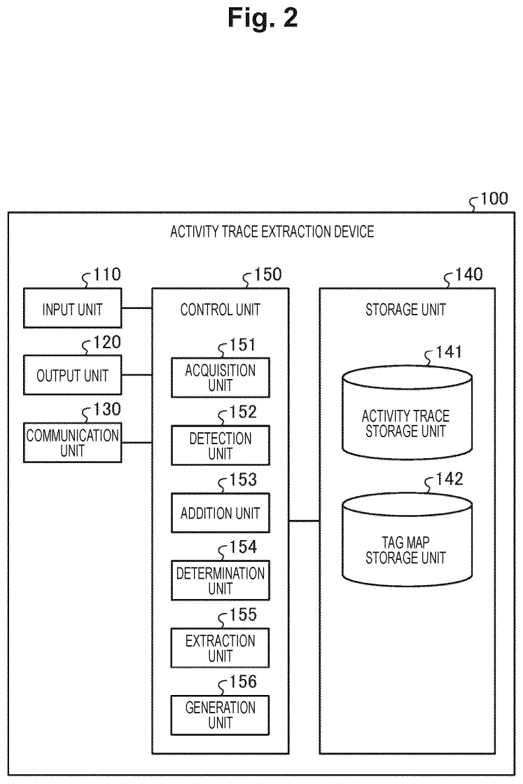

A configuration of the activity trace extraction device 100 according to the present embodiment will be described in detail with reference to FIG. 2. FIG. 2 is a block diagram illustrating a configuration example of the activity trace extraction device according to the present embodiment. The activity trace extraction device 100 includes an input unit 110, an input unit 120, a communication unit 130, a storage unit 140, and a control unit 150.

The input unit 110 controls input of various types of information to the activity trace extraction device 100. The input unit 110 is, for example, a mouse, a keyboard, or the like, and receives input of setting information or the like to the activity trace extraction device 100. In addition, the output unit 120 controls output of various types of information from the activity trace extraction device 100. The output unit 120 is, for example, a display or the like and outputs the setting information or the like stored in the activity trace extraction device 100.

The communication unit 130 controls data communication with other devices. For example, the communication unit 130 performs data communication with each communication device. In addition, the communication unit 130 can perform data communication with a terminal of an operator, which is not illustrated.

The storage unit 140 stores various types of information referred to when the control unit 150 operates and various types of information acquired when the control unit 150 operates. The storage unit 140 includes an activity trace storage unit 141 and a tag map storage unit 142. Here, the storage unit 140 is, for example, a semiconductor memory element such as a random access memory (RAM) or a flash memory, or a storage device such as a hard disk or an optical disc. Note that, in the example of FIG. 2, the storage unit 140 is installed inside the activity trace extraction device 100, but may be installed outside the activity trace extraction device 100, or a plurality of storage units may be installed.

The activity trace storage unit 141 stores an activity trace of malware detected by the detection unit 152 of the control unit 150. For example, the activity trace storage unit 141 stores a file, a registry manipulation, a specific file derived from malware generated through process generation or communication, or the like. In addition, the tag map storage unit 142 stores a tag map generated by the processing of the addition unit 153 of the control unit 150. For example, the tag map storage unit 142 stores a file and a memory to which a taint tag has been added by the taint analysis, information of related malware and API, and the like.

The control unit 150 controls the activity trace extraction device 100 as a whole. The control unit 150 includes an acquisition unit 151, a detection unit 152, an addition unit 153, a determination unit 154, an extraction unit 155, and a generation unit 156. Here, the control unit 150 is, for example, an electronic circuit such as a central processing unit (CPU) and a micro processing unit (MPU), or an integrated circuit such as an application specific integrated circuit (ASIC) and a field programmable gate array (FPGA).

The acquisition unit 151 acquires information regarding behavior of malware. For example, the acquisition unit 151 acquires API traces involved in network communication, file manipulation, registry manipulation, or process generation. In addition, the acquisition unit 151 may execute malware using an API tracer in an isolated environment to perform dynamic analysis for acquiring an API trace. The processing for the acquisition unit 151 to acquire the information regarding the behavior of malware is not particularly limited. The acquisition unit 151 may use static analysis that does not execute malware instead of dynamic analysis that executes malware. On the other hand, the acquisition unit 151 may store the acquired information regarding the behavior of malware in the storage unit 140.

The detection unit 152 detects an activity trace of malware on the basis of the information regarding the behavior of malware acquired by the acquisition unit 151. For example, the detection unit 152 lists in advance portions where traces are likely to remain at the time of malware activity, and detects traces appearing in the listed portions as the activity traces of malware. In addition, the detection unit 152 detects an activity trace of malware from API traces involved in network communication, file manipulation, registry manipulation, or process generation as a portion where the trace is likely to remain. On the other hand, the detection unit 152 stores the detected activity trace of malware in the activity trace storage unit 141.

The addition unit 153 executes taint analysis on malware, and in a case where the malware calls a predetermined API, adds a taint tag to an output value of the predetermined API based on the taint analysis executed by the addition unit 153. For example, in a case where malware calls an API for acquiring system information, time information, device information, or information specific to an application (appropriately referred to as a “system information acquisition API”), the addition unit 153 adds a taint tag to an output value of the API. In addition, the addition unit 153 executes malware on the taint analysis engine, adds a taint tag to the output value of the API described in the API list, propagates the taint tag in accordance with the data flow by the taint analysis engine, and generates a tag map in which a portion to which the taint tag has been added by propagation is recorded.

Meanwhile, the addition unit 153 stores the tag map in the tag map storage unit 142. Note that detailed taint analysis processing by the addition unit 153 will be described later in [Flow of Taint Analysis Processing].

The determination unit 154 determines the presence or absence of dependency of the activity trace detected by the detection unit 152 on the basis of the taint tag added by the addition unit 153. For example, the determination unit 154 determines the presence or absence of time dependency or environment dependency of the activity trace detected by the detection unit 152. In addition, the determination unit 154 determines that the activity trace has dependency in a case where the taint tag is added to the argument of the API corresponding to the activity trace detected by the detection unit 152. On the other hand, the determination unit 154 acquires a tag map including an activity trace to which a taint tag has been added from the tag map storage unit 142. In addition, the determination unit 154 may acquire an activity trace from the activity trace storage unit 141. Note that detailed dependency determination processing by the determination unit 154 will be described later in [Flow of Dependency Determination Processing].

In a case where the determination unit 154 determines that there is no dependency of the activity trace, the extraction unit 155 extracts the activity trace as an effective activity trace for detecting malware. For example, the extraction unit 155 excludes an activity trace determined to have dependency by the determination unit 154, and extracts only an activity trace determined to have no dependency as an effective activity trace. Meanwhile, the extraction unit 155 acquires an activity trace from the activity trace storage unit 141. Note that detailed activity trace extraction processing by the extraction unit 155 will be described later in [Flow of Activity Trace Extraction Processing].

The generation unit 156 generates malware trace information from an activity trace effective for detecting malware extracted by the extraction unit 155. For example, in order to detect a file name including a common character string detected as an activity trace, generation unit 156 generates trace information in which a character string other than the common character string is replaced with a symbol representing an arbitrary character string.

### [Specific Examples of Various Types of Information]

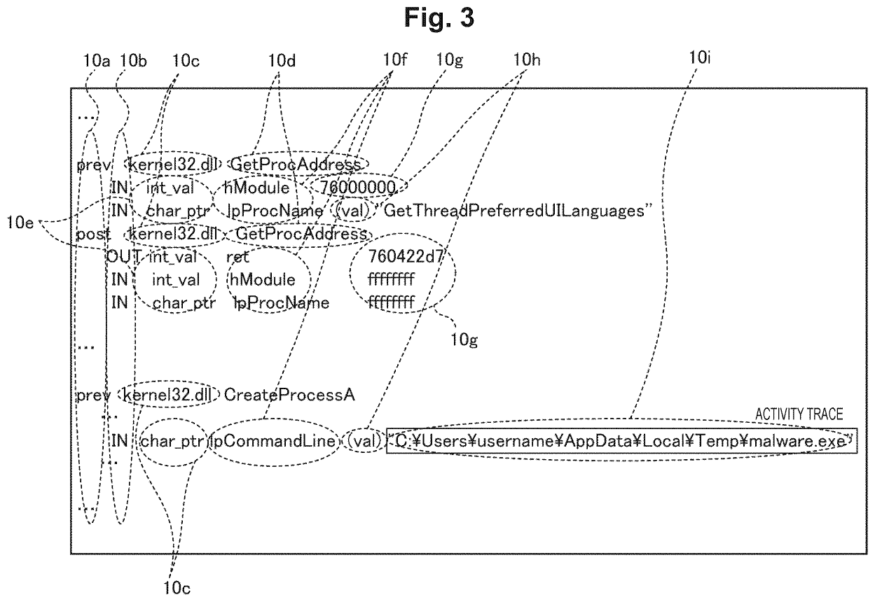

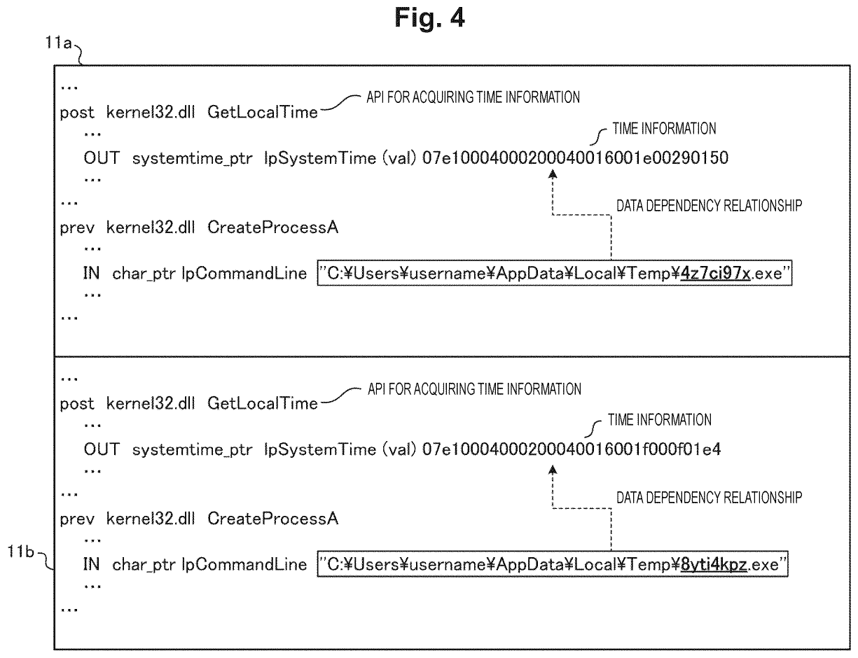

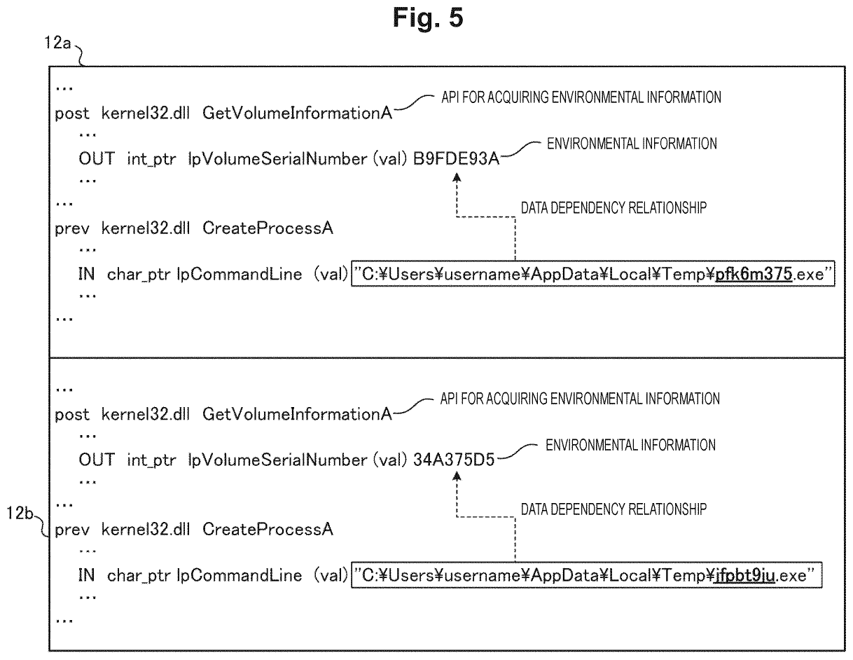

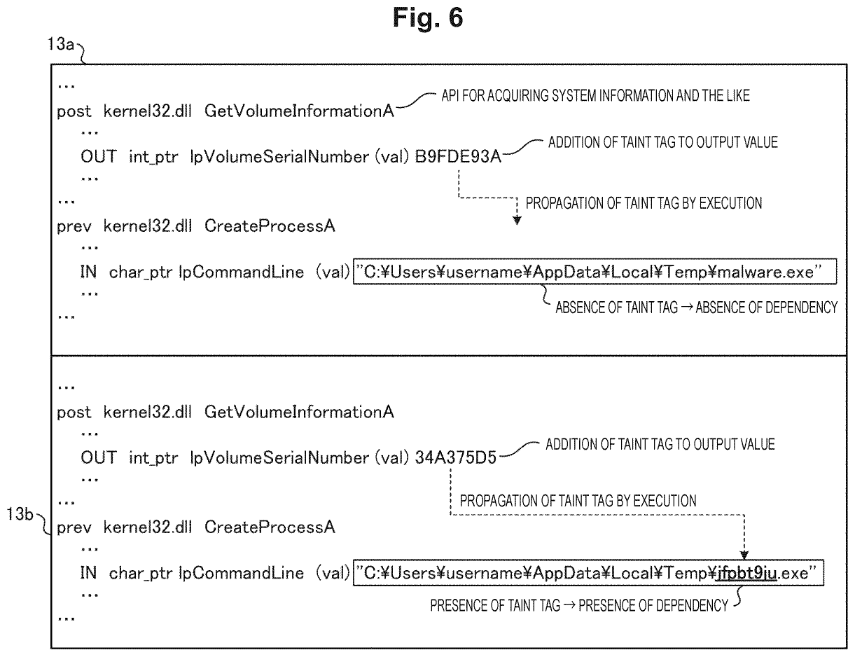

Specific examples of various types of information according to the present embodiment will be described in detail with reference to FIGS. 3 to 6. FIG. 3 is a diagram illustrating an example of an API trace and an activity trace according to the first embodiment. FIG. 4 is a diagram illustrating an example of a time-dependent activity trace according to the first embodiment. FIG. 5 is a diagram illustrating an example of an environment-dependent activity trace according to the first embodiment. FIG. 6 is a diagram illustrating an example of detection of an activity trace having dependency by a taint tag according to the first embodiment.

An example of the API trace and the activity trace will be described with reference to FIG. 3. In FIG. 3, “prev” included in an area 10a indicates before execution of the API, and “post” indicates after execution of the API. “IN” included in an area 10b indicates input, and “OUT” indicates output. A character string included in an area 10c indicates a DLL name. A character string included in an area 10d indicates an API name. A character string included in an area 10e indicates a type. A character string included in an area 10f corresponds to a variable name. A character string and numerical value included in an area 10g correspond to arguments. “val” included in an area 10h indicates that a value obtained by dereferencing a pointer is recorded. An area 10i includes an activity trace. The example illustrated in FIG. 3 shows that the lpCommandLine argument of CreateProcess is an activity trace related to a process in this malware.

An example of the time-dependent activity trace will be described with reference to FIG. 4. In FIG. 4, “GetLocalTime” is a system API for acquiring time information, and acquires time information of a system time. It is assumed that there is a data dependency relationship between “lpSystemTime” storing the system time, which is the output value of “GetLocalTime”, and the activity trace of the process name. That is, it is assumed that the process name is determined on the basis of the value of “lpSystemTime”. For example, in a case where there is a difference between the system time of an API trace 11a and the system time of an API trace 11b, the activity trace will also be different accordingly. This is time dependency.

An example of the environment-dependent activity trace will be described with reference to FIG. 5. In FIG. 5, “GetVolumeInformationA” is a system API, and acquires environmental information regarding a volume. It is assumed that there is a data dependency relationship between lpVolumeSerialNumber storing the serial number of the volume, which is the output value of “GetVolumeInformationA” and the activity trace of the process name. That is, it is assumed that the process name is determined on the basis of the value of the serial number of the volume. For example, in a case where there is a difference between the serial number of an API trace 12a and the serial number of an API trace 12b, the activity trace will also be different accordingly. This is environment dependency.

An example of detection of an activity trace having dependency by the taint tag will be described with reference to FIG. 6. In FIG. 6, the activity trace extraction device 100 adds a taint tag to an output value of an API for acquiring time information, system information, and the like. Next, the activity trace extraction device 100 executes the taint analysis and propagates the taint tag in accordance with the data flow. Here, if there is a data dependency relationship between the output value of the aforementioned API and the activity trace, the taint tag propagates to the activity trace as indicated by 13b. On the other hand, if there is no data dependency relationship, the taint tag does not propagate to the activity trace as indicated by 13a. Then, the activity trace extraction device 100 checks a portion corresponding to the activity trace with reference to the tag map, and determines that there is dependency if the taint tag is attached, and determines that there is no dependency if the taint tag is not attached.

### [Flow of Entire Processing]

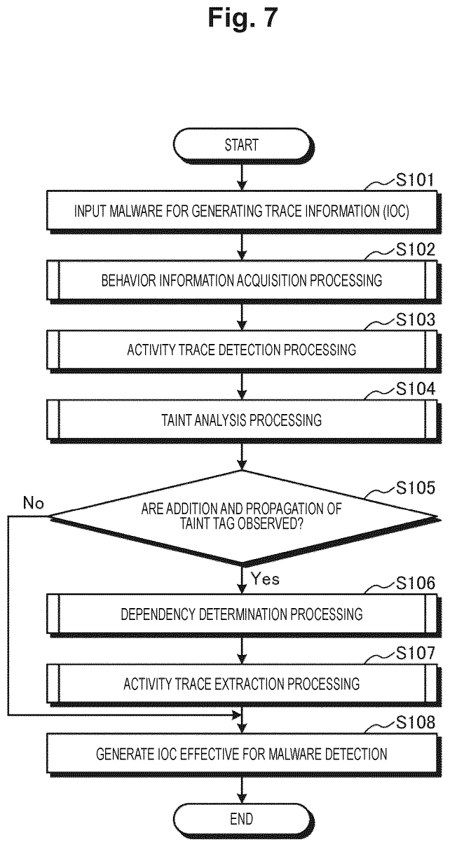

A flow of entire processing according to the present embodiment will be described in detail with reference to FIG. 7. FIG. 7 is a flowchart illustrating an example of a flow of entire processing according to the first embodiment.

First, the acquisition unit 151 of the activity trace extraction device 100 receives an input of malware as a target for generating trace information (IOC) from the user terminal 20 (step S101). At this time, the acquisition unit 151 may acquire malware information from a device other than the user terminal 20. In addition, the acquisition unit 151 may acquire malware information directly input via the input unit 110.

### (Behavior Information Acquisition Processing)

The acquisition unit 151 analyzes the behavior of malware and acquires behavior information that is an information source for obtaining an activity trace (step S102). At this time, the acquisition unit 151 analyzes the behavior by executing malware while monitoring it in an isolated environment. For example, the acquisition unit 151 monitors API call of malware and acquires an API trace. In addition, the acquisition unit 151 monitors a file, a registry, communication, and the like. That is, the acquisition unit 151 acquires behavior information of malware by monitoring API call or monitoring a file, a registry, communication, or the like. Note that the processing for the acquisition unit 151 to acquire the behavior information of malware is not particularly limited. In addition, the behavior information of malware acquired by the acquisition unit 151 may be an API trace or information obtained by monitoring a file, a registry, communication, or the like, and is not particularly limited.

### (Activity Trace Detection Processing)

The detection unit 152 acquires behavior information of malware from the acquisition unit 151. At this time, the detection unit 152 may acquire the behavior information of malware from a device other than the acquisition unit 151. Furthermore, the detection unit 152 may acquire malware behavior information directly input via the input unit 110.

In addition, the detection unit 152 detects an activity trace of malware from the acquired behavior information of malware (step S103). For example, the detection unit 152 lists in advance portions where traces are likely to remain at the time of malware activity (e.g.: arguments for API calls involved in network communication, file manipulation, registry manipulation, or process generation), and detects traces appearing in the listed portions as the activity traces of malware. Note that processing for the detection unit 152 to detect an activity trace of malware is not particularly limited.

### (Taint Analysis Processing)

The addition unit 153 executes taint analysis on malware (step S104). Here, the taint analysis is a method of tracking a data flow by adding and propagating a taint tag indicating attribute information. For example, the addition unit 153 executes malware on the taint analysis engine. At this time, the addition unit 153 adds the taint tag to the output value of the API for acquiring the system information and the like. Specifically, the API for acquiring the system information and the like and the output portion thereof are listed in advance and received as an API list. During execution of the taint analysis, the added taint tag is propagated in accordance with the data flow by processing of the taint analysis engine.

On the other hand, the addition unit 153 stores a tag map in which a portion to which a taint tag has been added by propagation is recorded in the tag map storage unit 142. The stored tag map is used to determine whether an activity trace depends on system information or the like in dependency determination processing to be described later. Note that detailed taint analysis processing by the addition unit 153 will be described later in [Flow of Taint Analysis Processing].

At this time, in a case where addition and propagation of the taint tag are observed (step S105: Yes), the addition unit 153 proceeds to the dependency determination processing in step S106. On the other hand, in a case where addition and propagation of the taint tag are not observed (step S105: No), the addition unit 153 proceeds to step S108.

### (Dependency Determination Processing)

The determination unit 154 determines the presence or absence of dependency of the activity trace of malware on the basis of the activity trace detected in step S103 and the taint tag added in step S104 (step S106). Note that detailed dependency determination processing by the determination unit 154 will be described later in [Flow of Dependency Determination Processing].

### (Activity Trace Extraction Processing)

The extraction unit 155 selectively extracts only an activity trace having no dependency from the activity traces detected in step S103 on the basis of the presence or absence of dependency of the activity trace determined in step S106 (step S107). Note that detailed activity trace extraction processing by the extraction unit 155 will be described later in [Flow of Activity Trace Extraction Processing].

Finally, the generation unit 156 generates an IOC effective for malware detection from the activity trace extracted in step S107 (step S108), and ends the processing. At this time, the generation unit 156 may output the generated IOC via the output unit 120. The generation unit 156 may transmit the generated IOC to the security countermeasure organization 30 via the communication unit 130.

### [Flow of Taint Analysis Processing]

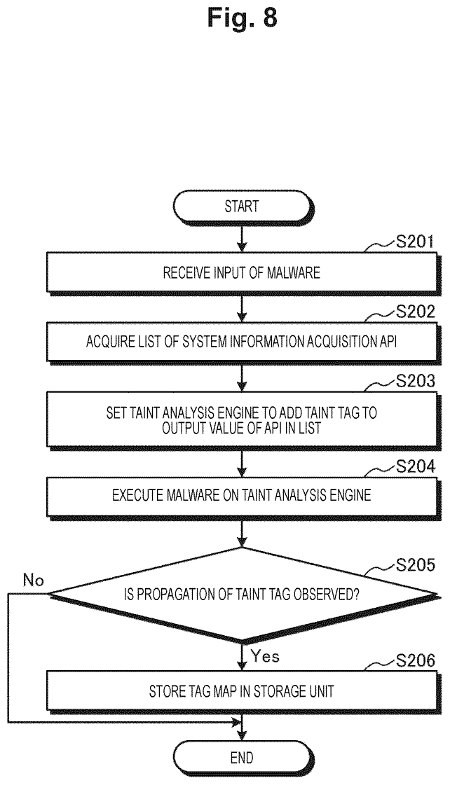

A flow of the taint analysis processing according to the present embodiment will be described in detail with reference to FIG. 8. FIG. 8 is a flowchart illustrating an example of a flow of taint analysis processing according to the first embodiment. First, the acquisition unit 151 of the activity trace extraction device 100 receives an input of malware as a target for generating trace information (IOC) (step S201).

Next, the addition unit 153 acquires the API list of the system information acquisition API from the API list database 40 (step S202). At this time, the addition unit 153 may acquire the API list from a source other than the API list database 40. Furthermore, the addition unit 153 may acquire the API list directly input via the input unit 110.

In addition, the addition unit 153 sets the taint analysis engine to add a taint tag to the output value of the API described in the API list (step S203). Then, the addition unit 153 executes the malware that has been received as an input in step S201 on the taint analysis engine set in step S203 (step S204). At this time, the addition unit 153 adds a taint tag to the output value of the API described in the API list, and propagates the output value in accordance with the data flow.

Finally, in a case where propagation of the taint tag is observed (step S205: Yes), the addition unit 153 stores the tag map including the propagation destination in the tag map storage unit 142 (step S206). On the other hand, in a case where the propagation of the taint tag is not observed (step S205: No), that is, in a case where there is no data flow from the output value of the API, the addition unit 153 ends the processing. According to the above processing, by adding the taint tag to the output value of the API for acquiring the system information and the like, the flow of data from the output value can be tracked, and it can be determined that the activity trace to which the tag has been added has dependency.

### [Flow of Dependency Determination Processing]

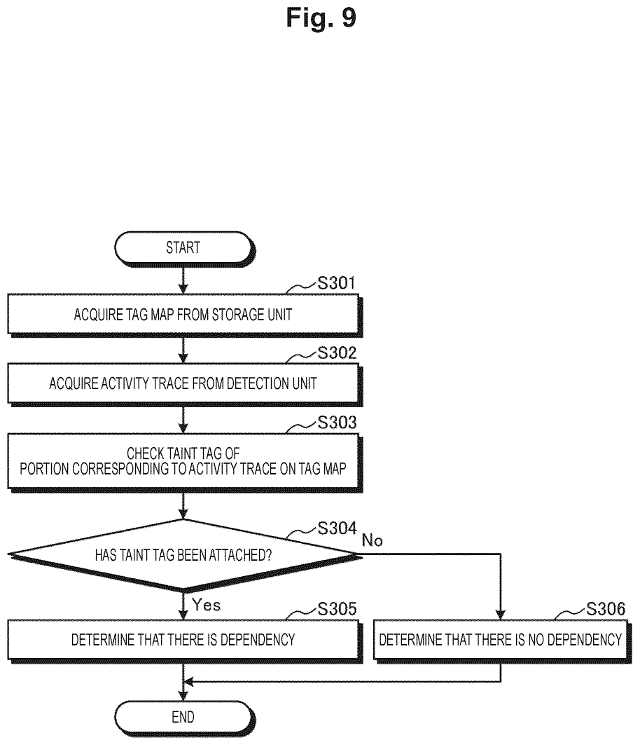

A flow of the dependency determination processing according to the present embodiment will be described in detail with reference to FIG. 9. FIG. 9 is a flowchart illustrating an example of a flow of dependency determination processing according to the first embodiment. First, the determination unit 154 of the activity trace extraction device 100 acquires a tag map from the tag map storage unit 142 (step S301). In addition, the determination unit 154 acquires one activity trace of malware detected by the detection unit 152 (step S302). Note that the processing in step S301 and the processing in step S302 may be performed simultaneously. Furthermore, the processing of step S302 may be performed before the processing of step S301.

Next, the determination unit 154 checks the taint tag of the portion corresponding to the activity trace acquired in step S301 on the tag map acquired in step S302 (step S303). At this time, in a case where the taint tag has been attached to the corresponding portion, that is, the corresponding activity trace (step S304: Yes), the determination unit 154 determines that there is dependency of the activity trace (step S305), and ends the processing. On the other hand, in a case where the taint tag has not been attached (step S304: No), the determination unit 154 determines that there is no dependency of the activity trace (step S306), and ends the processing. Note that the determination unit 154 may repeatedly perform steps S301 to S306 until the processing of all activity traces of malware detected by the detection unit 152 is ended.

### [Flow of Activity Trace Extraction Processing]

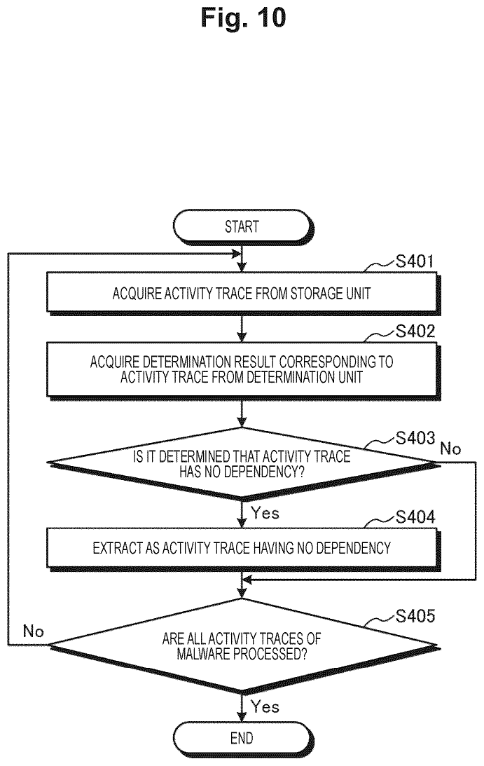

A flow of the activity trace extraction processing according to the present embodiment will be described in detail with reference to FIG. 10. FIG. 10 is a flowchart illustrating an example of a flow of activity trace extraction processing according to the first embodiment. First, the extraction unit 155 of the activity trace extraction device 100 acquires one activity trace from the activity trace storage unit 141 (step S401). The extraction unit 155 acquires a determination result corresponding to the activity trace determined by the determination unit 154 (step S402). Note that the processing in step S401 and the processing in step S402 may be performed simultaneously.

Next, in a case where it is determined that the activity trace has no dependency (step S403: Yes), the extraction unit 155 outputs the activity trace as an activity trace that has no dependency and is effective for detecting malware that generates the activity trace (step S404). On the other hand, in a case where it is not determined that the activity trace has no dependency (step S403: No), the extraction unit 155 proceeds to step S405.

Then, in a case where the processing of all activity traces of malware detected by the detection unit 152 is ended (step S405: Yes), the extraction unit 155 ends the processing. On the other hand, in a case where the processing of all activity traces of malware is not ended (step S405: No), the extraction unit 155 returns to step S401 and repeats the processing.

### Effects of First Embodiment

First, in the activity trace extraction processing according to the present embodiment described above, information regarding the behavior of malware is acquired, an activity trace of malware is detected on the basis of the acquired information regarding the behavior of malware, and taint analysis is executed on the malware. In a case where the malware calls a predetermined API, a taint tag based on the taint analysis is added to an output value of the API, presence or absence of dependency of an activity trace is determined on the basis of the added taint tag, and in a case where it is determined that there is no dependency, the activity trace is extracted as an activity trace effective for detecting the malware. Therefore, in this processing, it is possible to precisely detect the presence or absence of dependency of the activity trace on the basis of the tracking of the data flow of the malware, and selectively extract the activity trace effective for detecting the malware without dependency.

Second, in the activity trace extraction processing according to the present embodiment described above, in a case where malware calls an API for acquiring system information or the like, a taint tag based on taint analysis is added to an output value of the API, and the presence or absence of time dependency or environment dependency of an activity trace is determined. Therefore, in this processing, it is possible to precisely detect the presence or absence of dependency of the activity trace on the basis of the tracking of the data flow of the malware, and more effectively and selectively extract the activity trace effective for detecting the malware without dependency.

Third, in the activity trace extraction processing according to the present embodiment described above, API traces involved in network communication, file manipulation, registry manipulation, or process generation are acquired. Therefore, in this processing, it is possible to more efficiently acquire the activity trace of the extraction target, precisely detect the presence or absence of dependency of the activity trace on the basis of the tracking of the data flow of the malware, and selectively extract the activity trace effective for detecting the malware without dependency.

Fourth, in the activity trace extraction processing according to the present embodiment described above, in a case where a taint tag based on taint analysis is added to an argument of an API corresponding to an activity trace, it is determined that the activity trace has the dependency, and trace information of malware is generated from the extracted activity trace effective for detecting malware. Therefore, in this processing, it is possible to precisely detect the presence or absence of dependency of the activity trace on the basis of the tracking of the data flow of the malware, selectively extract the activity trace effective for detecting the malware without dependency, and generate the effective trace information.

### [System Configuration and Others]

Each component of each device that has been illustrated according to the embodiment described above is functionally conceptual and does not necessarily have to be physically configured as illustrated. In other words, a specific form of distribution and integration of individual devices is not limited to the illustrated form, and all or part of the configuration can be functionally or physically distributed and integrated in any unit according to various loads, usage conditions, and the like. Furthermore, all or any part of each processing function performed in each device can be implemented by a CPU and a program to be analyzed and executed by the CPU or can be implemented as hardware by wired logic.

Further, among the individual processing described in the embodiment described above, all or part of the processing described as being automatically performed can be manually performed, or all or part of the processing described as being manually performed can be automatically performed by a known method. In addition, processing procedures, control procedures, specific name, and information including various types of data and parameters illustrated in the specification and the drawings can be arbitrarily changed unless otherwise specified.

### [Program]

In addition, it is also possible to create a program in which the processing executed by the activity trace extraction device 100 described in the embodiment described above is described in a language that can be executed by a computer. In this case, the computer executes the program, and thus, the effects similar to those of the embodiment described above can be obtained. Further, the program may be recorded in a computer-readable recording medium, and the program recorded in the recording medium may be read and executed by the computer. Thereby, processing similar to the embodiment described above may be realized.

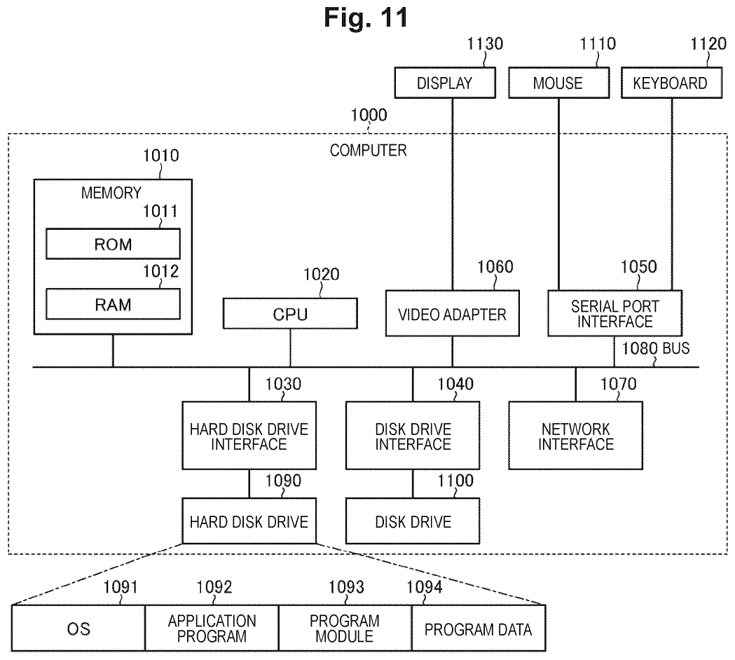

FIG. 11 is a diagram illustrating a computer that executes a program. As illustrated in FIG. 11, a computer 1000 includes, for example, a memory 1010, a CPU 1020, a hard disk drive interface 1030, a disk drive interface 1040, a serial port interface 1050, a video adapter 1060, and a network interface 1070. These units are connected by a bus 1080.

As illustrated in FIG. 11, the memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090 as illustrated in FIG. 11. The disk drive interface 1040 is connected to a disk drive 1100 as illustrated in FIG. 11. For example, a removable storage medium such as a magnetic disk or an optical disk is inserted into the disk drive 1100. As illustrated in FIG. 11, the serial port interface 1050 is connected to, for example, a mouse 1110 and a keyboard 1120. As illustrated in FIG. 11, the video adapter 1060 is connected to, for example, a display 1130.

Here, as illustrated in FIG. 11, the hard disk drive 1090 stores, for example, an OS 1091, an application program 1092, a program module 1093, and program data 1094. In other words, the above program is stored, for example, in the hard disk drive 1090 as a program module in which a command to be executed by the computer 1000 is described.

Further, various types of data described in the embodiment described above is stored as program data in, for example, the memory 1010 and the hard disk drive 1090. Then, the CPU 1020 reads out the program module 1093 and the program data 1094 stored in the memory 1010 and the hard disk drive 1090 to the RAM 1012 as necessary and executes various processing procedures.

Note that the program module 1093 and the program data 1094 related to the program are not limited to being stored in the hard disk drive 1090 and may be stored in, for example, a removable storage medium and may be read by the CPU 1020 via a disk drive, or the like. Alternatively, the program module 1093 and the program data 1094 related to the program may be stored in another computer connected via a network (such as a local area network (LAN) or a wide area network (WAN)) and may be read by the CPU 1020 via the network interface 1070.

The embodiment described above and modifications thereof are included in the inventions recited in the claims and the equivalent scope thereof, similarly to being included in the technique disclosed in the present application.

### REFERENCE SIGNS LIST

1 Activity trace extraction system
100 Activity trace extraction device
110 Input unit
120 Output unit
130 Communication unit
140 Storage unit
141 Activity trace storage unit
140 Tag map storage unit
150 Control unit
151 Acquisition unit
152 Detection unit
153 Addition unit
154 Determination unit
155 Extraction unit
156 Generation unit
20, 20A, 20B, 20C User terminal
30, 30A, 30B, 30C Security response organisation
40 API list database

1. An activity trace extraction device comprising:
acquisition circuitry that acquires information regarding behavior of malware;
detection circuitry that detects an activity trace of the malware based on the information acquired by the acquisition circuitry;
addition circuitry that executes taint analysis on the malware and adds a taint tag based on the taint analysis to an output value of a predetermined application programming interface (API) in a case where the malware calls the API;
determination circuitry that determines presence or absence of dependency of the activity trace based on the taint tag added by the addition circuitry; and
extraction circuitry that extracts the activity trace as an activity trace effective for detecting the malware in a case where the determination circuitry determines that there is no dependency.

2. The activity trace extraction device according to claim 1, wherein:
the addition circuitry adds the taint tag to the output value in a case where the malware calls the API for acquiring system information, time information, device information, or information specific to an application, and
the determination circuitry determines presence or absence of time dependency or environment dependency of the activity trace.

3. The activity trace extraction device according to claim 2, wherein:
the acquisition circuitry acquires an argument of an API call involved in network communication, file manipulation, registry manipulation, or process generation.

4. The activity trace extraction device according to claim 1, wherein:
the determination circuitry determines that the activity trace has the dependency in a case where the taint tag is added to an argument of the API corresponding to the activity trace, and
the activity trace extraction device further comprises a generation circuitry that generates trace information of the malware from the effective activity trace extracted by the extraction circuitry.

5. An activity trace extraction method, comprising:
acquiring information regarding behavior of malware;
detecting an activity trace of the malware based on the information acquired by the acquisition step;
executing taint analysis on the malware and adding a taint tag based on the taint analysis to an output value of a predetermined API in a case where the malware calls the API;
determining presence or absence of dependency of the activity trace based on the taint tag which has been added; and
extracting the activity trace as an activity trace effective for detecting the malware in a case where it is determined in the determination that there is no dependency.

6. A non-transitory computer readable medium storing an activity trace extraction program which when executed by a computer causes the computer to perform:
acquiring information regarding behavior of malware;
detecting an activity trace of the malware based on the information acquired by the acquisition step;
executing taint analysis on the malware and adding a taint tag based on the taint analysis to an output value of a predetermined API in a case where the malware calls the API;
determining presence or absence of dependency of the activity trace based on the taint tag which has been added; and
extracting the activity trace as an activity trace effective for detecting the malware in a case where it is determined in the determination that there is no dependency.
